(19) United States
(12) Patent Application Publication
(10) Pub. No.: US 2002/0124260 A1
(43) Pub. Date: Sep. 5, 2002

(54) Video production system for vehicles

(75) Inventor: Gary J. Rivera, Redondo Beach, CA (US)

Correspondence Address: Michael Zarrabian, Esq., Suite 500, 1925 Century Park East, Los Angeles, CA, 90067, US

(73) Assignee: Creative design Group, Inc.

(21) Appl. No.: 09/798,512

(22) Filed: Mar. 2, 2001

(51) Int. Cl. H04N 7/173

(52) U.S. Cl. 725/105; 348/159; 348/148; 348/588

(57) ABSTRACT

A video recording system for operation onboard vehicles, and for vehicle promotion and education, includes multiple video cameras, each camera having a video signal output, at least one of the cameras can be aimed inside a vehicle, and at least one of the cameras can be aimed outside the vehicle; a video screen generator having multiple inputs and at least one output, wherein each camera output is in transmitting connection with an input of the video screen generator for generating video images including video signals from two or more of the video cameras; and at least one video recorder having an input in transmitting connection with said at least one output of the video screen generator for recording said video images.

### FIELD OF THE INVENTION

The present invention relates to video production, and more particularly to video photography and recording for vehicles.

### BACKGROUND OF THE INVENTION

Video photography and recording (“videography”) equipment such as video cameras and video recording equipment are used for capturing and recording images.

Video equipment has been used to document the performance of component parts or systems such as brakes, tires, suspension systems, safety equipment, and the like. In training programs, video equipment has been used to record presentations designed to educate either internal staff at manufacturing organization or, at retail (e.g., automotive dealerships), technicians or sales personnel.

In marketing, video equipment has been used to suggest how vehicles look and can be used by end buyers/drivers. The vehicles videotaped for marketing purposes are shown being driven by individuals and the settings and manner of driving are consistent with the type of vehicle being marketed (e.g., sports cars are shown on curving roads or race tracks, sport utility vehicles are shown being driven off road, minivans are shown on suburban streets, pickup trucks are shown hauling boat trailers, etc.). In marketing as in product development and training, a camera is used in photography, and the camera is positioned outside the vehicle at a distance.

The video images so captured by conventional video photography (e.g., for automobiles), undergo an editing process and then are typically shown as follows: for product development and testing, on video playback equipment within the manufacturing organization; for training, on video playback equipment found either within the manufacturing organization or retail automotive dealerships; for marketing, on a variety of playback equipment depending on the end usage. The video images can also be shown in a theatrical setting as part of a meeting, shown at a consumer-oriented event as part of a product presentation, or broadcast over the Internet or, occasionally, on television.

Further, video cameras have also been used in vehicles such as automobiles, aimed outside the automobile to capture images of the passing terrain. The video images so generated are shown on a screen such as TV screen. A disadvantage of conventional videography equipment is that the images on the screen represent video output of one camera at a time. As such, images captured from different cameras must be shown on the screen in sequence.

Conventional videography equipment have been used outside a moving vehicle to capture images of the moving vehicle and then show such images as commercials for viewing on television, or distributed as promotional video tapes to potential car buyers. Though potential car buyers test drive cars before purchase, such test drives are one-time, short experiences which are by their nature onerous and worsen the car buying experience. After the test drive, the potential car buyer is provided with a car brochure, and occasionally with a generic promotional video tape for the car. Unfortunately, such promotionals are not effective and the test drive experience becomes a distant memory.

There is, therefore, a need for videography method and system for vehicles which provides multiple camera images on a screen. There is also a need for such a videography method and system to provide video images and recording of a driver's driving experience of a vehicle. There is also a need for such a method and system to provide usage of video photography at consumer marketing events, provide cameras in moving vehicles, provide use of multiple cameras, provide more effective vehicle promotion and marketing, provide consumers with a means to remember and, conceivably, relive the test drive experience with family members, friends, and business associates, thus adding to the sales value of the event and test driving experience.

### SUMMARY OF THE INVENTION

The present invention satisfies these needs. In one embodiment the present invention provides a video recording system for operation onboard vehicles includes: multiple video cameras, each camera having a video signal output, at least one of the cameras can be aimed inside a vehicle, and at least one of the cameras can be aimed outside the vehicle; a video screen generator having multiple inputs and at least one output, wherein each camera output is in transmitting connection with an input of the video screen generator for generating video images including video signals from two or more of the video cameras; and at least one video recorder having an input in transmitting connection with said at least one output of the video screen generator for recording said video images.

One version of the present invention provides a video recording system for operation onboard moving vehicles, wherein the various camera outputs are used to generate multiple images on a single screen (e.g., one image showing the view outside the vehicle and one showing the view inside); and one or more video recorders to record the images.

Further, the present invention provides a vehicle promotion and education method using video photography at consumer marketing events, in moving vehicles, using multiple cameras, for promotional and marketing purposes with consumers, and for helping consumers remember and, conceivably, relive the experience with family members, friends, and business associates, thus adding to the sales value.

### BRIEF DESCRIPTION OF THE DRAWINGS

These and other features, aspects and advantages of the present invention will become better understood with regard to the following description, appended claims and accompanying drawings where:

FIG. 1 shows a schematic diagram of an embodiment of a video recording system for operation onboard a vehicle according to an aspect of the present invention;

FIG. 2 shows a schematic diagram of an example installation of the components of the video recording system in an automobile according to the present invention;

FIG. 3 shows an example video screen output of the video recording system;

FIG. 4 shows a schematic diagram of another embodiment of a video recording system according to another aspect of the present invention; and

FIG. 5 shows example flowchart of steps of an embodiment of vehicle promotion/education method according to the present invention.

Like reference numbers and designations in the drawings refer to like elements.

### DETAILED DESCRIPTION OF THE INVENTION

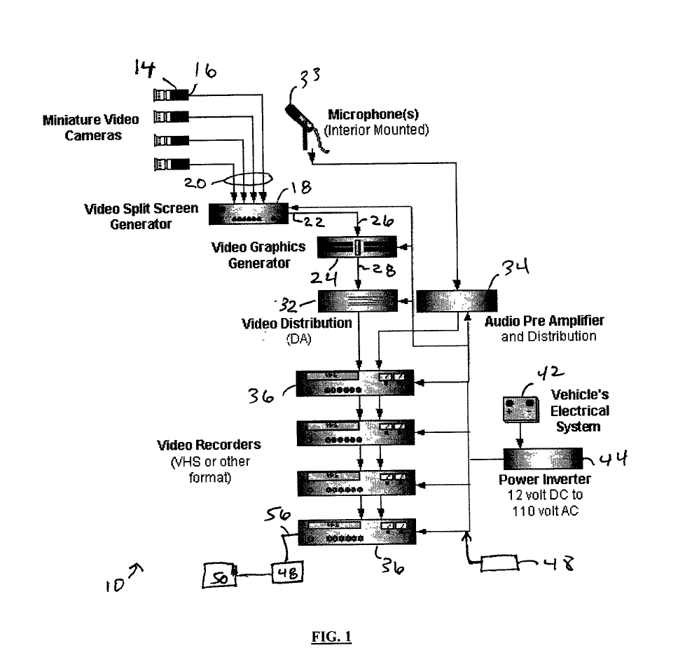

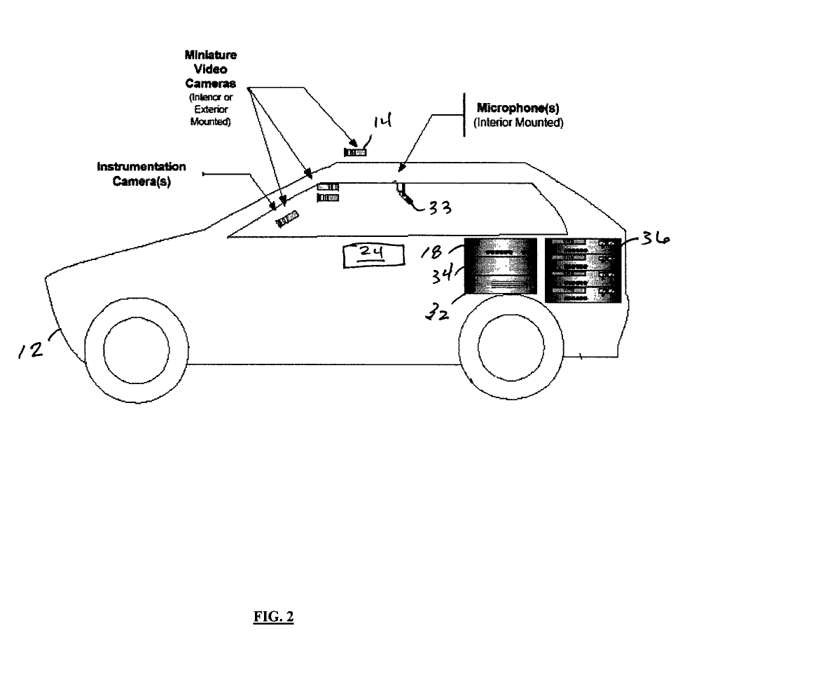

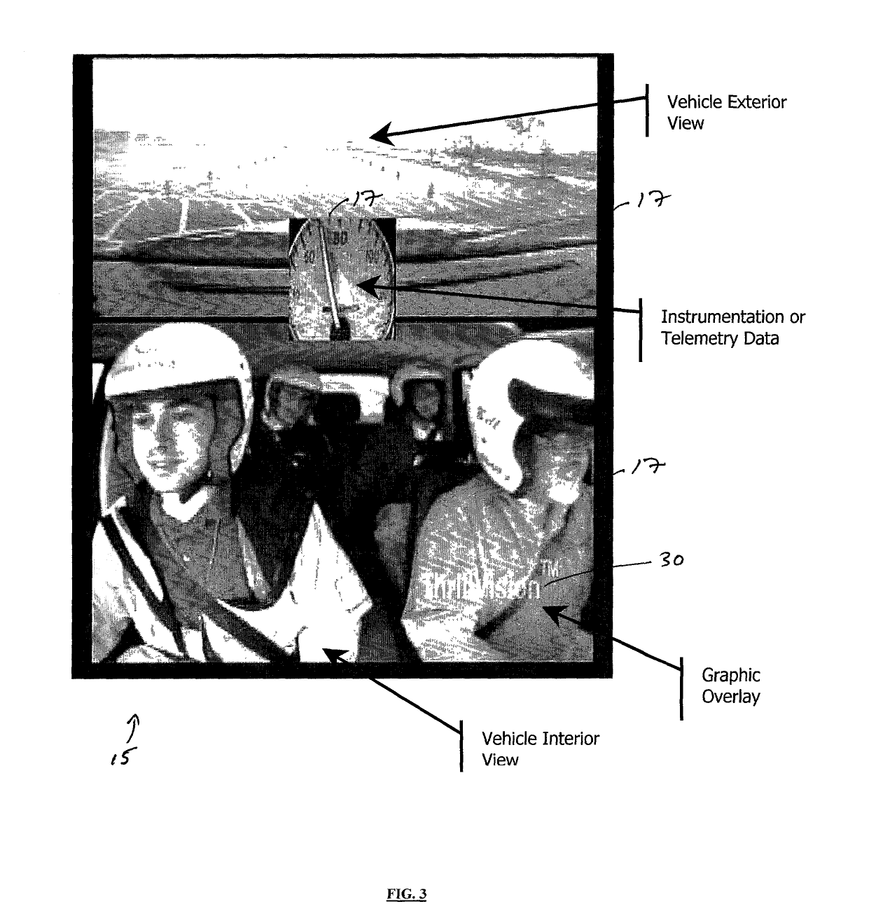

FIG. 1 shows an example schematic diagram of an embodiment of a video recording system 10 for operation onboard a vehicle 12 (FIG. 2) according to an aspect of the present invention. The video recording system 10 includes multiple video cameras 14, each camera having a video signal output 16. The video recording system further includes a video screen generator 18 having multiple inputs 20 and at least one output 22. Output of each camera 14 is in transmitting connection with an input of the video screen generator 18, and the video screen generator 18 generates video images 15 (FIG. 3) including video signals from two or more of the video cameras 14. In one embodiment, the video screen generator 18 comprises a video split screen generator, also known as a video scaler, for combining separate video signals representing images from different cameras 14 into a single image 15 including multiple “windows” of different images 17 (FIG. 3). An example of such a video screen generator 14 is from Ferral (™) Model QS-400. The windows' size, shape, and position are infinitely adjustable and are arranged to create the most visually compelling montage.

FIG. 2 shows a schematic diagram of an example installation of the components of the video recording system 10 in an automobile 12 according to the present invention. Although an automobile 12 is shown as an example vehicle, the present invention is useful for other vehicles including land going vehicles (e.g., trucks, motorcycles, etc.), air craft, water going vehicles (e.g., boats). Therefore, the present invention is not limited to use with automobiles.

As shown in FIG. 2, at least one of the cameras 14 can be aimed outside the vehicle, providing an occupant's point-of-view (POV) perspective. In one example, at least one camera 14 points forward, providing the perspective of an occupant's forward point-of-view. Further, at least one the cameras 14 can be aimed inside the vehicle 12 to capture images of e.g. occupants. Other cameras 14 can be aimed/trained on the driver and passenger's faces. Additional cameras can capture instrumentation inside the vehicle 12 (e.g., speedometer) and other appropriate imagery inside and/or outside the vehicle 12.

The cameras 14 can comprise miniature video cameras, referred to as “lipstick” cameras. The cameras 14 can be mounted on the interior or the exterior of the vehicle 12 using mounting means. An example of such a “lipstick” camera 12 is the Sony XC 99 (™). The mounts can comprise e.g. c-clamps, spring-loaded, suction cup, or Velcro-based.

As such, in one version, the video recording system 10 allows capturing video images of individuals (e.g., driver and/or passengers) inside the moving vehicle 12 (e.g., automobile, boat, aircraft, etc.) from one or more cameras 14 aimed inside the vehicle 12, while simultaneously capturing images shot outside the vehicle 12 (e.g., forward, backward, sideways) from one or more cameras 14 aimed outside the vehicle 12. Additional cameras 14 can be positioned on the vehicle 12 to capture appropriate instrumentation such as speedometer, tachometer, accelerometer, stick shift, etc.

Referring to FIG. 3, in one example, video images comprise split screen video images 15 including video signals representing images 17 from two or more of said cameras 14. Video images 17 of the driver and passengers are combined with video images taken looking out the front of the vehicle with other video images (e.g., images of the instrument panel). Multiple images 15 (e.g., three) are combined into a single video image 15 using multiple windows and/or a split screen.

Referring back to FIG. 1, optionally, the video recording system 10 can further include a video graphics generator 24 for generating video signals representing graphics images. The video graphics 24 generator has an input 26 in transmitting communication with the output of the video screen generator 18, and an output 28. The video graphics generator 24 combines/superimposes the video images 17 and graphics images 30 to provide an output signals representing a combination of said video images and the graphics images (combined video images shown in FIG. 3). As such, the video images from the video screen generator 18 including video signals from one or more of the cameras 14 is combined with the graphics images 30. For example, the video graphics generator 24, inserted inline, can provide additional graphic information on the windowed screen 15, such as corporate logos, event theme logos, marketing messages, or data from speed measurement and other sensors, superimposed on the screen. This video graphics generator 24 can also cause other information such as the time and date to be displayed on the screen.

The video graphics generator 24 can further include other data generation means wherein the data is converted to video and combined or superimposed on the video image output of the video screen generator 18. For example, speed, altitude, or directional information received from a GPS (Global Positioning System) unit could be integrated into the video image. Further, the video screen generator 14 can receive video input(s) from other video sources including telemetry data generated by sensors placed in, and connected to, the vehicle, engine or other components. Such addition video is combined into the final split-screen image 15.

As shown in FIG. 1, the video recording system 10 can further include a video distribution component 32 (e.g., video amplifier) coupled to the output of the video screen generator 14 and/or to the video graphics generator 24 for e.g. amplifying and stabilizing the video images. In one embodiment, the video amplifier comprises a video Distribution Amplifier (DA) for amplifying, splitting and stabilizing the video signal output of the video screen generator for recording or transmission. In one version, a distribution amplifier 32 splits a single video signal and sends it to multiple devices while maintaining original signal integrity. An example of such a DA is the Extron (™) Model CVDA 6 MX.

Further, the video recording system 10 can include at least one microphone 33 for generating an audio signal representing sounds inside and/or outside the vehicle 12. The video recording system 10 can further include at least one audio preamplifier 34 for amplifying audio signals, wherein output of the microphone 33 is connected to the audio pre-amplifier 34. The video recording system 10 further includes at least one video recorder 36 (e.g, VCR) having inputs in transmitting connection (e.g., electrical connection) with the outputs of the video screen generator 14, the video graphics generator 24, the audio pre-amplifier 34 and/or the video distribution component 32 for recording said audio/video images. In one example, multiple videotape decks (VCRs) or other appropriate recording devices 36 (e.g., DVD recorder, tape recorder, CD-ROM recorder, magnetic disk drive, etc.), record the video and audio signals to recording media (e.g., DVD, video tape, CR-ROM, magnetic disks). The video/audio and other information can be stored on magnetic media (e.g., tape, magnetic disk, etc.) and/or optical media (e.g., CD-ROM). Further said information can be digitized and stored as digital data on various magnetic or optical media, or transmitted (e.g., over a computer network). In one example microphone(s) 33 capture occupant's voices, environmental, and engine sounds. Low-level audio signals from the microphone(s) can be amplified and prepare for recording or transmission via e.g. the audio preamplifier 34 connected to the video recorders 36.

In the FIG. 1 example, signals flow from video cameras 14 through, consecutively, the video split-screen generator 18, the video graphics generator 24, and the video distribution component 32 to video recording devices 26 that can be physically contained within a moving vehicle 12. FIG. 1 also shows flow of audio signals from microphones 33 to the audio amplification equipment 34 and the video distribution and recording equipment 32, 36, respectively.

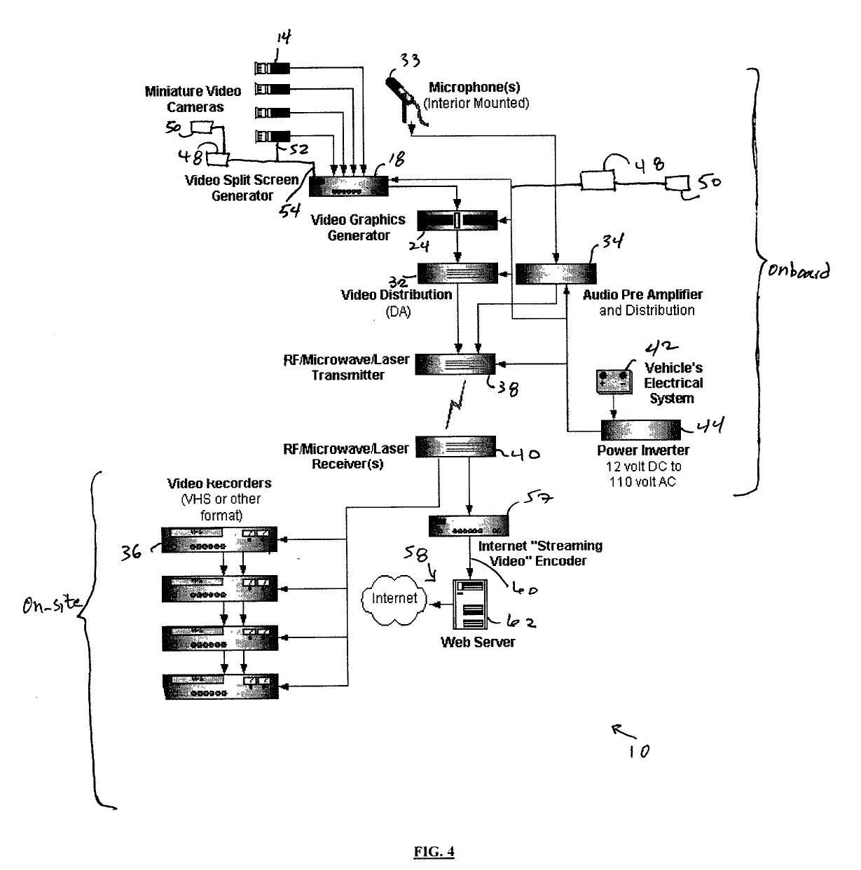

The FIG. 2 example shows all components of the video recording system 10 installed in the vehicle 12. However, other installation methods and configurations are possible, wherein the cameras 14 are installed in the vehicle 12, and one or more other components of the video recording system 10 are installed either in the vehicle 12 or remain in one or more location outside the vehicle 12 (e.g., a control center building, track pit area, etc). In that case, as shown by example in FIG. 4, the components of the video recording system 10 installed in the vehicle 12 can communicate with components of the video recording system 10 installed in remote locations outside the vehicle 12 via e.g. wireless communication devices including wireless transmitters 38 and receivers 40. Examples of wireless communication devices 38, 40 include radio frequency (RF) transmitters and receivers, infra red (IR) transmitters and receivers, microwave transmitters and receivers, video transmitters and receivers, laser transmitters and receiver, etc. As such, examples of transmitting connection herein include e.g. electrical connection, wireless connection, microwave, etc. depending on the location of the components of the video recording system 10 and the desired mode of connection between said components (e.g., direct connection, wireless, etc.).

Further, one or more of the components of the video recording system 10 can be powered by e.g. the vehicle's power supply 42 via an adapter 44, internal batteries, or be connected to another power supply as appropriate. For example, most vehicles 12 provide 12 volt DC electrical power. One or more of the components of the video recording system 10 (e.g., video cameras 14, video recorders 36, wireless transmitter devices 38, etc.) can be installed onboard the vehicle 12 can be configured to use said 12 v DC voltage. Other components of the video recording system 10 that can be installed onboard 12 the vehicle may require 110 volt AC power, wherein an onboard power inverter 44 is utilized to convert the vehicles 12 v DC to the require 110 v AC. In one version, one or more of the components of the video recording system 10 installed onboard the vehicle 12 can be mounted in shock-resistant equipment racks and secured within the vehicle's cargo area 46 with nylon straps (FIG. 2).

In the example FIG. 4, one or more components of the video recording system 10 (e.g., front-end devices such as cameras 14, microphones 33, video screen generator 18, video graphics generator 24, video distribution component 36 and audio amplifier 34) are installed in the vehicle 12 and one or more other components of the video recording system 10 (e.g., video recorders 36) are installed in a remote location outside the vehicle 12. FIG. 4 shows signal flow from said front-end devices to wireless transmitting equipment 38 within the vehicle 12 to remotely located receiving equipment 40. The audio/video signal output from the distribution component 36 and the amplifier 34 are input to the wireless transmitter 38 (e.g., video transmitter and antenna apparatus) installed on the vehicle 12 for transmission. Such transmitters 38 provide the ability to simultaneously transmit both sound and picture. A wireless receiver 40 at a stationary (or mobile) location outside the vehicle 12 receivers the transmitted audio/video signals. The received audio/video signals can be monitored for quality. The receiver 40 can further separate the video and audio signals, and video recorders 36 at said location outside the vehicle 12 record the received video and audio signals. Other options for installing some of the components of the video recording system 10 on-board the vehicle 12 and other components of the video recording system 10 in other locations are possible as desired.

In another embodiment of the video recording system 10, each of one or more of onboard components of the video recording system 10 (e.g., at least one camera 14, video screen generator 18, video recorder 36, etc.) can include a control input 48 coupled to an onboard wireless receiver 50 for receiving control signals sent by a transmitter outside the vehicle for remotely controlling the operation of such components. For example, the cameras 14 can include control inputs 52 for zooming, re-aiming, etc. The video screen generator 18 can include control inputs 54 for using images from different cameras 14, choice of split screen format, etc. The video recorders 14 can include control inputs 56 for recording speed, dubbing, etc.

In various embodiments of the invention, the video signals to be recorded can also be transmitted via an interface 57 over a computer network 58 (e.g., Internet) through a communication link 60. In one version, the interface 57 comprises a real-time streaming encoder for converting the video and audio signals into data for transmission over the computer network (e.g., compatible with Internet browsers and media players such as those available from Microsoft(™) and Real networks (™). The streaming video signal is directed to an Internet Web server 62 for direct connection to the World Wide Web. Participants are then invited to visit a specific Web site to view their drive/flight. The Web site can include additional links relating to a host company's product and services.

The recorded video images (e.g., VHS tape, CD, etc.) and/or the streaming video images can be distributed in a variety of methods according to the present invention. For example, all captured images can be transferred immediately, at the test drive site for a vehicle, to a videotape cassette for distribution as is appropriate. At the conclusion of a vehicle test drive, the driver/passengers can receive a recorded videotape copy of their in-vehicle experience, information directing them to visit an Internet Web site to view their captured images. Participant's videotapes and/or streaming video may contain additional pre-recorded video greetings and other appropriate marketing messages.

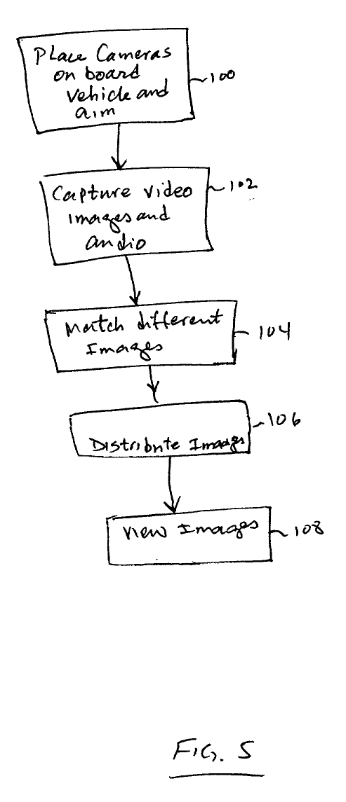

As shown by example in FIG. 5, in one aspect the present invention provides steps including: placing cameras onboard a vehicle (step 100), capturing a video image of occupants inside a vehicle and other images (step 102), matching the video images to footage shot simultaneously outside the vehicle (step 104), and transferring the footage, on site, to an appropriate distribution media (e.g., recording, Internet, etc.) (step 106), enhancing the immediacy of the experience for the end users (e.g., consumers or retail sales staff in promotion or training). The images are then viewed by individuals (step 108). Further, overall quality of the video images is maintained by using “broadcast quality” equipment to capture and record images for distribution to consumers in an automotive sales environment. This video documentation (e.g., video tape) proves memorable for people in the vehicle and can be a factor motivating or inducing a motor vehicle purchase or lease by the consumer taking the test drive. The present invention allows immediate, on-site transfer of the formatted images to distribution media (e.g., tape/CD recordings, Internet, etc.) and designed for distribution to potential vehicle buyers. The distributed images can be viewed as often as desired. Further the images can be distributed via lease or renting options.

Further, the video documentation can be a broader marketing tool, enhancing the image of the specific vehicle and its manufacturer via showing of the video to friends, co-workers, etc. The present invention can be applied by scenic destination operators, providing aircraft passengers and sightseers a memorable video record of their experience.

In one version, the simultaneously record and matched images from inside and outside the vehicle are formatted wherein the resulting footage includes multiple windows within a single video screen (e.g., split screen), described above. According to the present invention, preferably the cameras 14 are placed and aimed to capture images that convey the feeling of the entire experience—inside and outside the vehicle 12. For example, multiple camera positions in the vehicle 12 are established, designed to capture the entire vehicle interior so that all passengers see themselves in the final video, and vehicle instrumentation such as speedometer, tachometer, etc. (e.g., FIG. 3). Further, exterior-view vehicle cameras are mounted to show driver's point-of-view, looking out over the hood of the vehicle, and wheel-well cameras are designed to capture a close-up view of the ground as it passes by, enhancing the feeling of speed. The images from various cameras are matched/manipulation into multiple on-screen windows.

On-site (FIG. 4), and in-vehicle (FIG. 2), duplication and recording equipment, facilitates the immediate distribution of the resulting footage. Foe example, when consumers complete their in-vehicle experience, they can simply be handed a videocassette showing the multiple windows and images. Further, the resulting video an be transmitted over a network such as the Internet. Various formats of the finished video output according to the present invention enables distribution e.g. either immediately, on site (via videocassette or other physical media) or via streaming over Internet-based media

The inventor's broad experience in the field of consumer-oriented marketing and training automotive events, enabled the inventor to understand the requirements of end use by potential buyers or lessees of motor vehicles. According to the present invention, courses are developed which allow consumers (e.g., the participants) to drive one or several of the sponsoring manufacturer's model lineup. The course can be designed to show off, to best effect, the positive attributes of the vehicle(s). Most such events emphasize the performance attributes of the vehicles. These attributes include capabilities such as acceleration, braking, road-handling, the ability to maintain a high level of speed when cornering. The event is designed to include, and usually conclude with, a “hot lap”, during which a professional driver (normally) or the consumer/potential buyer (occasionally) takes the vehicle at high speed around a specially designed course loop.

According to the present invention, footage subjects are determined to be captured on video i.e., image content, as interior images, alone, may not successfully convey the experience of speed that is usually the entire point of the hot lap. Therefore, vehicle interior images are blended with simultaneously shot exterior images. The images are combined in a format that accurately and fully conveys the driving experience for participants on the final, distributed video, described herein. Adjustments to equipment, camera placement, finished distribution format, etc. allow the video recording system of the present invention to capture both the images and the feeling of the ride-along experience, described herein by way of example.

As such, in one example, the videos produced using the system and method of the present invention, shot from within the vehicle are of professional-quality, without requiring manipulation by cameramen. The present invention opens a new area of usage for video photography a) at consumer events, b) in moving vehicles, c) using multiple cameras, d) for promotional and marketing purposes with consumers, and e) to help consumers remember and, conceivably, relive the experience with family members, friends, and business associates, thus adding to the sales value.

As such, the present invention provides an advertising tool: to assist a potential vehicle buyer, and influence the potential buyer's decision to buy a particular vehicle; for vehicle promotion and education wherein users can replay recorded video images of e.g. a test drive to learn more about the tested vehicle.

Although the present invention has been described in considerable detail with regard to the preferred versions thereof, other versions are possible. Therefore, the appended claims should not be limited to the descriptions of the preferred versions contained herein.

What is claimed is:

1. A video recording system for operation onboard vehicles, comprising:
(a) multiple video cameras, each camera having a video signal output;
(b) a video screen generator having multiple inputs and at least one output, wherein each camera output is in transmitting connection with an input of the video screen generator for generating video images including video signals from two or more of the video cameras; and
(c) at least one video recorder having an input in transmitting connection with said at least one output of the video screen generator for recording said video images.

2. The video recording system of claim 1, wherein at least one of the cameras is aimed inside a vehicle, and at least one of the cameras is aimed outside the vehicle, such that at least a portion of the video images comprise split screen video images including video signals from the outside aiming camera and video signals from the inside aiming camera.

3. The video recording system of claim 1, wherein at least a portion of the video images comprise split screen video images including video signals from two or more of said cameras.

4. The video recording system of claim 1, wherein the video screen generator comprises a video split-screen generator, whereby at least a portion of the video images comprise split screen video images including video signals from two or more of said cameras.

5. The video recording system of claim 1, further comprising a video graphics generator coupled between the screen generator and the video recorder, the video graphics generator having an input in transmitting communication with the output of the video screen generator and an output in transmitting communication with the input of the video recorder, the video graphics generator generating graphics images and providing video output signals representing combination of said graphics images and said video images.

6. The video recording system of claim 1, further comprising a video distribution component coupled to said output of the video screen generator and said input of the video recorder for amplifying and stabilizing said video images for recording by the video recorder.

7. The video recording system of claim 1, further comprising at least one microphone for generating an audio signal representing sounds inside and/or outside the vehicle, and wherein the video recorder further includes an input in transmitting communication with said microphone for recording said audio signals.

8. The video recording system of claim 1, wherein:
at least one camera has a control input,
the video screen generator has a control input,
the video recorder has a control input,
the video recording system further including a wireless receiver in transmitting communication with the control inputs of said camera, the video screen generator and the video recorder, for receiving control signals to selectively control operation of one or more of said camera, the video screen generator and the video recorder.

9. A video production system for vehicles, comprising:
(a) multiple video cameras, each camera having a video signal output, wherein at least one of the cameras can be aimed inside a vehicle, and at least one of the cameras can be aimed outside the vehicle;
(b) a video screen generator having multiple inputs and at least one output, wherein each camera output is in transmitting connection with an input of the video screen generator for generating video images including video signals from two or more of the video cameras;
(c) a wireless transmitter for transmitting the video images; and
(d) a wireless receiver for receiving the transmitted video images.

10. The video production system of claim 9, wherein at least a portion of the video images comprise split screen video images including video signals from two or more of said cameras.

11. The video recording system of claim 9, wherein the video screen generator comprises a video split-screen generator, whereby at least a portion of the video images comprise split screen video images including video signals from two or more of said cameras.

12. The video recording system of claim 9, wherein at least one of the cameras is aimed inside a vehicle, and at least one of the cameras is aimed outside the vehicle, such that at least a portion of the video images comprise split screen video images including video signals from the outside aiming camera and video signals from the inside aiming camera.

13. The video recording system of claim 9, further comprising a video graphics generator coupled between the screen generator and the wireless transmitter, the video graphics generator having an input in transmitting communication with the output of the video screen generator and an output in transmitting communication with the wireless transmitter, the video graphics generator generating graphics images and providing video output signals representing combination of said graphics images and said video images.

14. The video production system of claim 9, further comprising a video distribution component coupled to said output of the video screen generator and said wireless transmitter for amplifying and stabilizing said video images before transmission.

15. The video production system of claim 9, further comprising at least one video recorder having an input in transmitting connection with said wireless receiver for recording said received video images.

16. The video recording system of claim 9, further comprising at least one microphone for generating an audio signal representing sounds inside and/or outside the vehicle, the transmitter further including means for transmitting the audio signals, the receiver further including means for receiving the transmitted audio signals.

17. The video production system of claim 16, further comprising at least one video recorder having an input in transmitting connection with said wireless receiver for recording said received video images and audio signals.

18. The video production system of claim 9, further comprising an interface interconnected to a computer network via a communication link, for communicating the received video images over the computer network.

19. The video production system of claim 18, wherein the interface comprise a streaming video controller for streaming the received video images over the computer network.

20. The video production system of claim 18, wherein the computer network comprises the Internet.

21. The video production system of claim 9, wherein:
at least one camera has a control input,
the video screen generator has a control input,
the video recording system further including a wireless receiver in transmitting communication with the control inputs of said camera and the video screen generator, for receiving control signals to selectively control operation of one or more of said camera and the video screen generator.

22. A video production method for vehicles, comprising the steps of:
(a) placing multiple video cameras onboard a vehicle, each camera having a video signal output;
(b) matching simultaneous video signals from at least two cameras to generate video images including video signals from said at least two cameras; and
(c) recording the video images.

23. The method of claim 22 wherein step (b) further includes the steps of providing a video screen generator having multiple inputs and at least one output, wherein each camera output is in transmitting connection with an input of the video screen generator for generating video images including video signals from said two or more of the video cameras.

24. The method of claim 22 wherein step (c) further includes the steps of providing at least one video recorder having an input in transmitting connection with said at least one output of the video screen generator for recording said video images.

25. The method of claim 22, wherein step (b) further includes the steps of matching simultaneous video signals from one of the cameras aimed outside the vehicle with video signals from one of the cameras aimed inside the vehicle, for generating said video images.

26. The method of claim 22, wherein step (b) further comprises the steps of generating the video images having split screen video images including video signals from two or more of said cameras.

27. The method of claim 22, further comprising the steps of generating video signals representing graphics images, wherein step (b) further includes the steps of combining said video images and the graphics images.

28. The method of claim 27, wherein the step of generating the graphics images video signals includes the steps of providing a video graphics generator for generating video signals representing said graphics images.

29. The method of claim 22, further comprising the steps of amplifying and stabilizing said video images for recording by the video recorder.

30. The method of claim 22, further comprising the steps of recording audio signals representing sounds inside and/or outside the vehicle.

31. The method of claim 22, wherein step (d) further includes the steps of:
providing a wireless transmitter to transmit the video images;
providing a wireless receiver to receive the transmitted video images; and
recording the transmitted video images.

32. The method of claim 31, further comprising the steps of communicating the received video images over a computer network.

33. The method of claim 32 wherein the step of communicating further includes the steps of:
providing an interface interconnected to the computer network via a communication link, for communicating the received video images over the computer network.

34. The method of claim 33, wherein the interface comprise a streaming video controller for streaming the received video images over the computer network.

35. The method of claim 32, wherein the computer network comprises the Internet.

36. The method of claim 22, wherein step (a) further includes the steps of aiming at least one of the cameras inside a vehicle, and aiming at least one of the cameras is outside the vehicle.

37. A method for vehicle promotion and education, comprising the steps of:
(a) placing one or more video cameras onboard a vehicle, each camera having a video signal output;
(b) processing video signals from said one or more cameras to generate video images including video signals from said one or more cameras;
(c) storing the video images; and
(d) providing the video images for viewing.

38. The method of claim 37, wherein step (d) further comprises the steps of distributing the video images for viewing by individuals for vehicle promotion and/or education.

39. The method of claim 37, wherein step (d) further comprises the steps of distributing the video images for sale and/or lease.

40. The method of claim 37, wherein step (a) further includes the steps of aiming at least one of the cameras on at least one passenger in the vehicle, wherein one or more of the video images include an image of the passenger.

41. The method of claim 40, wherein step (d) further comprises the steps of providing the video images to said passenger for later viewing.

42. The method of claim 37, wherein:
step (c) further comprises the steps of recording the video images; and
step (d) further comprises the steps of providing the video images to one or more individuals for viewing for vehicle promotion and education.

43. The method of claim 42, wherein:
step (c) further comprises the steps of recording the video images on at least one magnetic medium; and
step (d) further comprises the steps of providing said magnetic medium to said one or more individuals for viewing.

44. The method of claim 42, wherein:
step (c) further comprises the steps of recording the video images on at least one optical medium; and
step (d) further comprises the steps of providing said optical medium to said one or more individuals for viewing.

45. The method of claim 42, wherein step (d) further comprises the steps of providing the video images to said one or more over a computer network.

46. The method of claim 42, further comprising the step of:
(f) said at least one or more individuals viewing the video images.

47. The method of claim 37, wherein:
step (a) further comprises placing multiple video cameras onboard a vehicle, each camera having a video signal output; and
step (b) further comprises the steps of matching simultaneous video signals from at least two cameras to generate video images including video signals from said at least two cameras.
